(19) United States
(12) Patent Application Publication
(10) Pub. No.: US 2009/0097981 A1
(43) Pub. Date: Apr. 16, 2009

(54) Low Cost Wind Turbine

(75) Inventor: Christopher W. Gabrys, Reno, NV (US)

Correspondence Address: J. MICHAEL NEARY, 53939 Pine Grove Road, La Pine, OR, 97739, US

(73) Assignee: Mariah Power, Inc., Reno, NV (US)

(21) Appl. No.: 11/990,321

(22) PCT Filed: Aug. 11, 2006
(86) PCT No.: PCT/US06/31476

§ 371 Date: Feb. 11, 2008

Related U.S. Application Data
(60) Provisional application No. 60/707,643, filed on Aug. 12, 2005.

(51) Int. Cl. F03D 3/06; F03D 9/00

(52) U.S. Cl. 416/204 R; 290/55; 416/223 R

(57) ABSTRACT

A vertical axis wind turbine includes an elongated rotor propelled by wind-drag, having a high aspect ratio, with a length, L, and diameter, D, wherein 5<L/D≦15. The rotor is mounted on a pole adapted to be installed in the wind in a vertical orientation. The rotor is constructed from thin vane sheets that form two curved vanes that are supported along their vertical length by vertically extending rigid vane supports located at two different radial locations on the rotor, stiffened by radial ribs. The vane supports support the thin vane sheets and provide transfer of wind induced torque along the vane sheet length to a generator that is located at one end of the rotor and connected thereto to convert rotational energy of the rotor into electricity as the rotor rotates about the central pole and directly drives the generator rotor at the same rotational speed.

This invention pertains to a low cost small wind turbine that provides increased energy generation at low cost and desirable dynamic rotational performance while operating with low noise, easy installation and aesthetically pleasing appearance.

### BACKGROUND OF THE INVENTION

Use of wind turbines for electrical energy generation is currently growing because of their economical power production and environmental benefits. Large wind turbines, located in off shore or remote wind farms are increasingly being installed worldwide. They can produce megawatts of electric power with lower costs than many other types of power production, and they do not pollute.

Another application for wind turbines is in small wind turbines, typically of 10 kilowatts peak power or less. Such small wind turbines have been deployed on farms for providing some electricity production but their use has generally been limited. An additional emerging market opportunity for small wind turbines is in urban and suburban installations. In these installations, customers expect to be able to produce some of their own electric power and offset their utility bills through net metering. Urban and suburban wind turbines will be located where people live, with installations on rooftops, in yards and along roadsides. They will minimize electricity transmission losses and the need for additional transmission lines.

Unfortunately, small wind turbines currently suffer from substantial deficiencies that limit their use and are preventing their widespread adoption. Small wind turbines are currently much too expensive for the energy that they produce. They have less than ideal energy capture, conversion and efficiency. They typically employ complex and very costly constructions. Most small wind turbines are also noisy and require the use of towers that are unsightly and difficult to zone and install, both limiting their suitability for urban and suburban installations. Other deficiencies include noisy operation, rotor turbulence sensitivity, overspeed structural failure potential and avian-unfriendliness. Accordingly, a new type of low cost wind turbine is needed.

### SUMMARY OF THE INVENTION

The invention provides a low cost wind turbine that affords substantially increased energy generation per cost, along with much more desirable operating characteristics that allow for widespread deployment in rural, suburban and urban locations. The vertical axis wind turbine is constructed with a pole adapted to be installed in a vertical orientation, a drag propelled cross-wind harnessing rotor mounted on the pole, and an electric generator driven by the turbine. The rotor comprises two axially elongated, radially curved, fixed and axially untwisted rotor vanes mounted such that the rotor incurs a very high aspect ratio having a length, L, and diameter, D, wherein 5≦L/D. The rotor is constructed from thin replaceable vane sheets that form two curved vanes and are each supported along their vertical length by vertically extending rigid vane supports that are located at two different radial locations on the rotor. The vane supports support the vane sheets and provide transfer of the wind induced torque along the vane sheet length to the generator. The rotor further comprises multiple radial rib members that extend between the rigid vane supports at several different axial locations along the vertical length of the rotor. The radial rib members increase the radial bending stiffness of the rotor vanes in rotational operation. The rotor is supported to rotate about the pole by upper and lower bearings such that the pole operates as a stationary center shaft. The generator is located at one end of the rotor and is connected thereto to convert rotational energy of the rotor at the same rotational speed.

The combination of the turbine attributes has been found to provide an environmentally desirable and significantly lower cost small wind turbine. This low cost wind turbine is a vertical axis wind turbine with a drag-propelled rotor having a high aspect ratio. Coupled to the rotor is a generator for production of electric power. New wind turbines for potential installation in urban and suburban locations should be quiet. Drag propelled cross-wind harnessing wind turbines provide a potential significant advantage in that they operate at a low tip speed ratio. The tip speed ratio is the ratio of the speed of the tip of the rotor blade divided by the speed of the wind. Drag propelled wind turbines typically operate with tip speed ratios of under 2.1 whereas conventional small horizontal axis propeller type wind turbines have tip speed ratios from between 7 to 10. High tip speed ratio rotors cause noise as the blades push through the air. As a result, drag propelled wind turbines provide significantly quieter and even silent operation. They also instantly generate power from any direction wind and do not require tracking to face the turbine into the wind to generate power.

Unfortunately, the low tip speed ratio of drag propelled wind turbines also results in a significant disadvantage. To date, they have not gained widespread commercial acceptance. Most experts in the art agree that drag propelled wind turbines are inferior to horizontal axis propeller-type wind turbines, and they are not proponents of the commercial viability these types of wind turbines. Drag propelled turbines have typically had lower power coefficients and they have resultantly required use of a larger and heavier rotor. Further, they operate at lower speeds. Low rotational speeds require a much larger and more costly generator to generate the equivalent amount of electrical power. The generator costs limit the use of the Savonius or other types of drag propelled cross-wind harnessing wind turbines. The speed could potentially be increased through the use of a gearbox or transmission. However, this would have the adverse effects of unacceptable operating gear noise, maintenance and reliability issues, and increased cost.

To overcome the issues of low rotational speed of a drag propelled wind turbine, the wind turbine in accordance with this invention has a substantially reduced the rotor diameter and the rotor length is substantially increased. The total vane area can be maintained sufficient to capture the desired energy from the wind; however the reduced diameter affords a substantial increase in the rotational speed of the rotor and a substantial reduction in the cost of the generator. Because the rotor tip speed ratio can remain unchanged, for a given wind speed, the rotational rate increases linearly with reduced rotor diameter. In comparison with a conventional horizontal axis propeller wind turbine, the diameter of the drag-propelled rotor can be constructed approximately 4-5 times smaller. The rotational rate of the generator can actually be equivalent to that of an equivalently rated conventional wind turbine having a high tip speed ratio. The low cost wind turbine virtually eliminates the operating noise. Additional benefits also include the lack of a required tower, omni directional wind power generation, reduced wind turbulence sensitivity, and importantly a more aesthetically pleasing wind turbine compatible for widespread deployment.

The high aspect ratio of the drag propelled wind turbine results in several construction and operational issues that are problematic. One issue is a very flexible and long length rotor. Obtaining smooth and reliable dynamic operation of the rotor and insuring a structurally adequate construction with this design is important to trouble-free operation and commercial viability. Considerations to achieve low costs for the wind turbine include minimizing the weight of the wind turbine to reduce the material, shipment, and manufacturing costs, and design for simplified construction and assembly and the employment of low cost materials. While meeting these goals, the design also should allow for high rotor rotational speed, long rotor length and long distance for torque transfer from the turbine vanes.

To address and solve these issues, the rotor is constructed from thin vane sheets that form two curved vanes and are each supported along their vertical length by vertically extending rigid vane supports that are located at two different radial locations on the rotor. The vane supports support the thin vane sheets and provide transfer of the wind induced torque along the vane sheet length to the generator. Multiple radial rib members extend between the rigid vane supports at several different axial locations along the vertical length of the rotor. In an additional embodiment, the radial rib members are located on the leading face of the vanes. In this configuration, the ribs can utilize a curved profile that induces the curved shape to the thin vane sheets.

The small wind turbine provides a rotor that is lightweight and wherein the vanes are replaceable. The reduced weight, reduces the costs, facilitates shipping and makes installation easier. A preferred construction is to construct the rotor van supports from thin wall metal pipe and to produce the vane sheets from extruded plastic sheet. This sheet comes on rolls weighing from 500-2000 lbs, is flat and very low cost. Plastics have a density that is about 1/7^{th} that of steel. The plastic also costs roughly $2.00/lb which is more than ten times less costly than a composite material rotor. The vane sheets are easily replaceable when required because of UV degradation, weathering or operational damage. They are producible in any color, including clear. Additional advantages of the plastic vanes are that they provide near silent operation, whereas large metal vanes can act like drums and be exceedingly noisy and can be dented. The vane material is preferably a high toughness and good UV stability material. HDPE and polycarbonate have been found to be good materials. One issue with utilizing a flat extruded vane panels is that they are not in the correct airfoil shape to garner maximum energy capture from the wind. Further, they have low strength and low stiffness, preventing operation and the ability to maintain shape. However, the vane supports provide the required structural strength and stiffness to operate the turbine in high winds. The vane supports prevent the outer edges of the vanes from bowing outward and loosing shape. Further, they contain the vane sheets against the centripetal acceleration, which otherwise would tend to make them fly off.

A preferred configuration for the vane supports is to utilize hollow tubes. The tubes can be provided with axial slots for containing the vanes. It is conventionally believed that the leading and trailing edges should be made sharp so as to garner high energy capture efficiency with the rotor. As a result, the use of tubes at the leading and trailing edges or edges of the vanes sheets would appear to be a poor construction. Surprisingly, we have found that that the use of tubes supporting the vanes edges does not substantially impact the rotor power coefficient. The reason for the continued high rotor power coefficient is that drag propelled cross-wind harnessing operate by harnessing power throughout the whole rotation of the rotor. At low incident wind angles, typically 0-45 degrees, the rotor utilizes lift. At higher angles per half revolution, the rotor utilizes primarily drag. The effect of the leading edge on the energy capture would only affect the lift portion as it can cause flow separation from the vane. However, analysis of the flow shows that flow separation primarily only occurs at the angles not producing appreciable lift anyway, so they do not provide a significant deleterious effect as would be expected.

The rotor profile is preferably designed to maximize the power coefficient. Modified Savonius rotors increase the power coefficient by increasing the lift contribution to the torque production when at the low incidence angles. A drag propelled wind turbine would be considered as any cross-wind harnessing turbine that uses drag for a portion of its operation, or has the ability to self-start. Drag propelled cross-wind harnessing turbine rotors can be constructed with several different designs. Use of two vanes has been shown to produce the highest power coefficient, about 50% higher than rotors utilizing three vanes. Rotors with many vanes have also been constructed.

With the use of axially slotted vane support construction, the vanes can easily be slid axially into the rotor, and they can be very easily replaced when desired or necessary. Unlike a large metal Savonius rotor that would be much heavier and also easily dented making them unattractive unless the whole rotor is replaced, the replacable panel construction makes replacement of the panels very easy and at low cost. Panels for a 20 ft by 2 ft diameter rotor weigh only 15 lbs and cost approximately only $30. They do not dent, corrode, or resonate wind noise. They may eventaully suffer UV degradation, but are expected to last approximately ten years or more before needing replacement. In addition, the material is extruded into large rolls at low cost, and no expensive and time consuming large molding operations are need to produce the high efficiency airfoil profile. The lost cost rotor construction could also be advantageously utilized with a low aspect ratio rotor configuration, although it would not achieve the full advantages of the high speed rotation and reduced direct drive generator costs. The dynamic performance and resonances would also be altered.

Reduced rotor diameter increases the rotational speed for reducing generator size and costs. Although the rotor tip speed remains the same despite the reduced rotor diameter, the centrifugal loading on the rotor actually increases with reduced diameter. This increase is due to that fact that the loading is a squared function of the rotational rate. The long vertical length of the rotor makes the increased centrifugal loading deflection of the rotor even yet more substantial. The radial bending stiffness is however improved to handle the loading by the use of vertical vane supports for each vane located at two radial locations. The supports support the thin vane sheets to form the required curved vanes for wind energy capture. Radial ribs between the two vertical supports, at multiple vertically spaced locations, greatly increase the radial bending stiffness. The radial ribs in one embodiment can also preferably employ the vane cross-section shape so as to impart the desired shape to the vane sheet. The radial rib may also be located on the leading surface of the vane so as to contain the vane sheet against the forces imparted by the wind. Together, the ribs and vertical supports form a vertical beam that limits the radial centrifugal growth. Operation in high winds up to 80 mph or 35 m/sec has shown no problems.

I have found that the rotor aspect ratio affects the energy generation costs for the wind turbine. The aspect ratio or L/D, wherein L is the length of the rotor and D is the diameter of the rotor, is preferably chosen to be within the range of 5 to 15. Shorter aspect ratios have been found to increase the wind turbine cost per annual energy generation because of increased generator costs for direct drive generators. Likewise, higher aspect ratios also significantly increase the wind turbine costs per annual generation capability because of increased rotor costs. They can also impart difficulties of operation, assembly and transportation, depending on the power production size.

Another consideration in the wind turbine operation is in the dynamic performance of the rotor in rotation. Because of the high aspect ratio, the rotor vibrations can lead to large deflections that can adversely affect long-term reliable operation. It is desirable to limit the radial deflections of the rotor from resonances. I have found that, with the high aspect ratio, flexural resonances will occur, even though it would be desirable to eliminate them. For a given structural moment of inertia, the resonance is an inverse function of the cube of the rotor length. To limit the flexural deflections, the rotor bending moments of inertia are preferably designed to cause the first flexural critical speeds to occur at low speeds. Preferably, the first flexural modes, the ones with the largest geometric deflection capability, should occur below the lowest generating speed, or preferably below 4 m/sec wind speed. Passing through these resonances at very low speed significantly reduces the energy during resonance and limits the rotor deflections and stress. One effective attribute of the rotor construction with vane sheets being slid into the vane supports and rotor ribs is the ability of the vane panels to slide within the slots of the vane supports. This sliding induces friction that retards the vibrational motion of the rotor. The induced damping limits the rotor flexural deflections when passing through the flexural critical speeds, and allows very smooth operation.

The long rotor length causes other significant problems. For instance, a 1 kW wind turbine can require a rotor that is 20 ft long and only 2 ft wide. The long length and flexible construction cause significant length changes to occur in operation. Further, the rotor flexing also couples with the flexing of the center pole. In yet a further embodiment, at least one end of the rotor comprises an axial sliding connection that limits the axial loading between two of the bearings supporting the rotor. The sliding connection can be a slip fit with sliding room at the top bearing. Alternatively, it can be a slip bolted connection to the generator at the bottom end. For very long rotors employing a middle bearing, preferably both the upper and lower ends comprise axial sliding connections.

In one embodiment, the centrifugal loading growth is limited and flexural rotor stiffness increased by constructing the vertical supports from hollow tubes. The tubes provide higher rotor stiffness and less rotor weight. In other embodiments, the vertical supports clamp the vane sheets at the outer edges to reinforce them against the centrifugal force and to impart the desired vane curve profile to the vane sheet along the vertical length. One method of clamping is to utilize vertical slots in the vertical supports. The edges of the vane sheets are inserted into the slots in the vertical supports, preferably for full or near full rotor length support of the vane sheets. In yet a further embodiment, the rotor can be designed for readily replaceable vane sheets. Easy replacement, such as sliding, snapping into place, or even a few fasteners, can be very desirable for the operator. Also some operators may wish to change the color or graphics of the rotor with the seasons or even advertise on the rotor vane sheets.

In an additional embodiment, the rotor operates with a tip speed ratio between 0.7 to 2.1 at the point of maximum power coefficient to reduce the total wind turbine cost while maintaining low noise operation. More preferably, a high efficiency rotor design with both drag and lift components can operate with a tip speed ratio between 1.4 and 1.8 for increased energy generation per cost, with very low noise generation.

One key aspect of the low cost wind turbine is the generator that produces electric power from the rotational energy captured by the rotor. Generator efficiency, ability to produce power at low speeds and costs, are of importance to wind generators in general, and to small wind generators for the particular applications contemplated herein in particular. It is preferable that the generator be integrally designed with the wind turbine to reduce costs and installation complexity, and to provide a more attractive product. It is also desirable that the generator be directly driven by the rotor so as to eliminate transmission noise, losses, maintenance/reliability problems, and associated costs. It is further desirable to utilize the same rotor bearings of the wind turbine to support the generator rotor for operation. However, conventional electric generators have substantial internal magnetic attraction forces between the generator rotor and stator that need to be resisted to prevent contact between the generator rotor and stator. Because of the high aspect ratio of the turbine rotor and low bending rotor stiffness, a rotor and bearing system of reasonable cost may not provide sufficient support to resist the internal generator magnetic attraction. The rotor could simply bend slightly and the generator could have internal contact, which would interfere with its ability to spin freely and to produce power. To overcome this, an additional large bearing could be added in the generator. However, this adds significant cost, is difficult to protect from weather contamination because of the location, adds losses and weight, so it is not preferred. Instead, it is desirable to utilize a generator that does not impart rotor to stator magnetic attraction. It is further desirable to utilize a generator that can have large magnetic airgaps so that rotor deflections from wind loading, resonances or unbalances do not cause internal generator contact. Accordingly, the low cost wind turbine preferably employs an air core configuration generator attached to and driven by the rotor. More preferably, the generator employs a double rotating permanent magnet air core generator topology. The generator is constructed of multiple permanent magnet poles that drive magnetic flux across an armature airgap. The armature airgap contains an air core armature with multiple electrical windings, and the armature airgap is bounded on both surfaces by rotating surfaces of the generator rotor. The generator has no generator rotor-to-stator attraction, can produce power with high efficiency because of a lack of steel stator magnetic induced losses, and can have large magnetic airgaps (10-20 times larger than a conventional generator) to prevent generator internal contact during the wind turbine operation. The construction further eliminates generator cogging and allows easy start up of the turbine even in low wind speeds.

### DESCRIPTION OF THE DRAWINGS

FIG. 1A is a schematic elevation of a low cost wind turbine in accordance with the invention.

FIG. 1B is a plan view of the low cost wind turbine shown in FIG. 1A.

FIG. 2 is a plot of the energy generation cost versus the L/D ratio of the wind turbine rotor.

FIG. 3 is a graph comparing the rotor flexural bending stiffness with and without the use of rib supports.

FIG. 4 is a schematic drawing of a rotor vane without ribs in operation.

FIG. 5 is a schematic drawing of a rotor vane with ribs in operation in accordance with the invention.

FIG. 6A is a diagram of the rotor bending deflection of the rotor shown in FIGS. 1A and 11 at its first flexural critical about the minimum inertia axis.

FIG. 6B is a schematic drawing of the rotor cross-section of the rotor shown in FIG. 6A showing the direction of the minimum inertia axis.

FIG. 7A is a diagram of the rotor bending deflection of the rotor shown in FIGS. 1A and 11 at its first flexural critical about the maximum inertia axis.

FIG. 7B is a schematic drawing of the rotor cross-section shown in FIG. 7A showing the direction of the maximum inertia axis.

FIG. 8A is a diagram of the rotor bending deflection of the rotor shown in FIGS. 1A and 11 at its second flexural critical about the minimum inertia axis.

FIG. 8B is a schematic drawing of the rotor cross-section shown in FIG. 8A showing the direction of the minimum inertia axis.

FIG. 9 is a graph comparing the rotor centrifugal force versus the rotor L/D ratio for two rotors with the same power generation capacity.

FIG. 10 is a dynamic plot of the rotor deflections with wind speed in accordance with the invention.

FIG. 11 is a cross-sectional plan view of the of the rotor shown in FIG. 1A.

FIG. 12 is a schematic drawing of the top end of a low cost wind turbine in accordance with the invention.

FIG. 13 is a schematic drawing of the bottom end of a low cost wind turbine in accordance with the invention, showing a schematic view of a generator.

FIG. 14 is a schematic drawing of an alternate configuration of the bottom end of a low cost wind turbine in accordance with the invention.

FIG. 15 is a schematic drawing of roll of extruded vane plastic accordance with the invention.

FIG. 16 is a schematic elevation of a rotor frame in accordance with the invention, showing the vane supports and radial rib members.

FIG. 16A is a plan view of one of the ribs in the rotor frame shown in FIG. 16.

FIG. 17 is a schematic diagram of the pitching moment generation on a single vane of a rotor in accordance with the invention.

FIG. 18 is a plot of the moment coefficient versus the angle of incidence of impending wind for a rotor in accordance with the invention.

FIG. 19 is a diagram of a rotor profile showing the torque production from both lift and drag, in accordance with the invention.

FIG. 20 is a plot of the rotor torque coefficient versus the rotor operating tip speed ratio for different profile rotors, in accordance with the invention.

FIG. 21 is a plot of the rotor power coefficient versus the rotor operating tip speed ratio for different profile rotors, in accordance with the invention.

### DESCRIPTION OF THE PREFERRED EMBODIMENTS

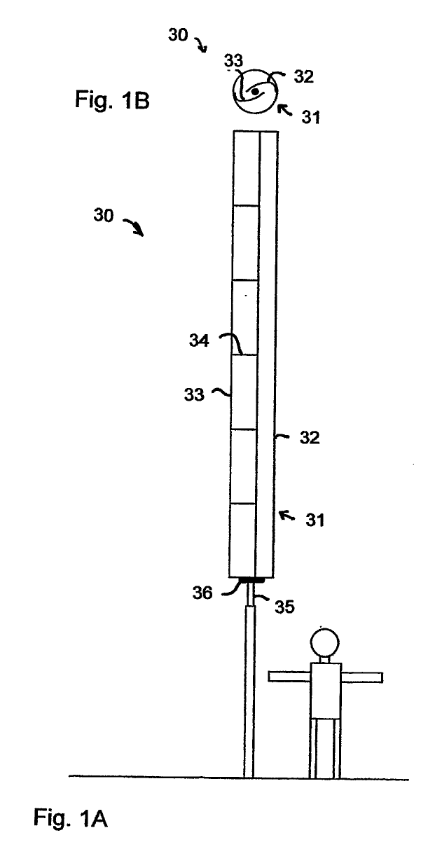

Turning to the drawings, wherein like reference characters designate identical or corresponding parts, FIGS. 1A and 1B show a low cost wind turbine 30 having a rotor 31 with an aspect ratio, L/D of approximately 10, a length of 18 feet, a diameter of 22 inches, and a power capability of 1 kW. The rotor 31 is constructed from two curved sheet vanes 32 and 33 that catch the wind. Multiple radial ribs 34, spaced vertically apart along the vertical height, radially stiffen the rotor 31. The wind turbine 30 further comprises a generator 36 that converts the rotation of the rotor 31 into electrical power. The rotor 31 is journalled for rotation about a stationary central shaft pole 35.

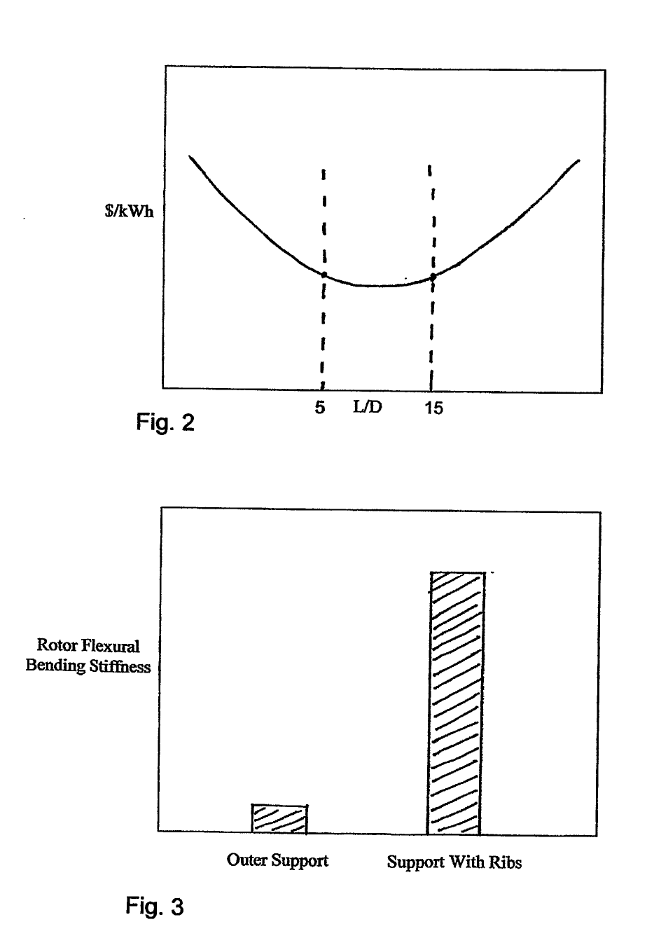

I have found that the aspect ratio, or ratio of rotor length divided by rotor diameter, is of importance to the economic viability of the wind turbine. Increasing the aspect ratio allows for a reduction of the rotor diameter while still maintaining the same rotor area for energy capture. The reduced diameter thereby increases the rotor rotational rate for a given wind speed and operating tip speed ratio. As a result of the higher rotational rate, the costs of the electrical generator can be significantly reduced and no gearbox or speed increaser transmission is required. Further, the tall and slender wind turbine is much more attractive, unobtrusive and easily installable in urban and suburban locations. However, we have also found that increasing the aspect ratio of the wind turbine rotor too much can result in other problems. A plot of the energy generation cost versus the wind turbine L/D ratio is shown in FIG. 2. At very high aspect ratios, the costs for the wind turbine per energy generation increase because of costs associated with the rotor. The operation of the wind turbine and assembly of the rotor become more costly. Likewise, depending on the power capacity of the wind turbine, the transportation of the rotor can also be more difficult and costly at very high aspect ratios. As a result the rotor preferably is designed to utilize an aspect ratio that ranges between 5 and 15 for the most economical energy generation.

The high aspect ratio of the turbine rotor results in several difficulties that must be overcome in order to achieve successful operation. One issue is the rotor flexural bending stiffness because of the long length and small diameter. The bending stiffness affects rotor resonance, radial deflections and centrifugal loading. To support the rotor vanes, vertical rigid supports are included on the rotor for each vane at two different radial locations. The vertical supports hold the rotor together and allow for the vanes to be constructed from lightweight and low cost sheets of material such as plastic or even sheet metal flashing, depending upon the installation requirements. However, the vertical supports alone provide only a moderate rotor bending stiffness and strength against their own centrifugal loading. To increase the rotor bending stiffness and strength without adding significant weight and cost to the rotor, the rotor preferably also has radial rib members 34 that extend radially between the vertical supports at axially spaced locations. A comparison of the rotor flexural bending stiffness with and without the use of rib supports 34 is shown in FIG. 3. Without the radial ribs 34, the outer supports carry the loading essentially alone. The addition of the radial ribs transfers the loading between the two radially spaced vertical supports and substantially increases the bending stiffness and strength of the rotor vane. The ribs with the vertical supports form a beam for the rotor vanes to allow the wind turbine to operate properly without large deflections or substantial outward bending in the center when rotating.

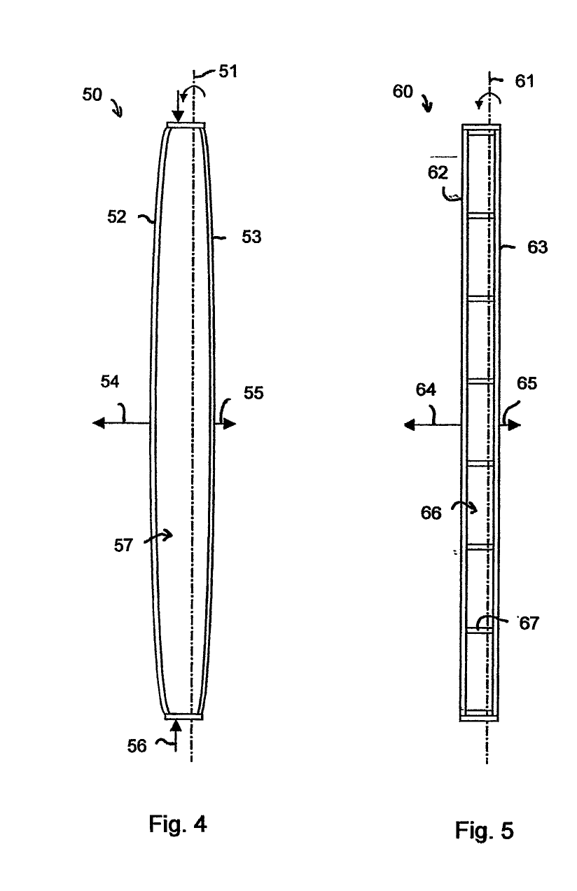

A schematic drawing of a rotor frame without ribs in operation is shown in FIG. 4. The rotor frame 50 rotates about an axis of rotation 51 and is constructed from two vertical supports 52, 53 for each vane (only one of which is shown for clarity of illustration) that are located at two different radial locations. The vertical supports 52, 53 are preferably constructed from hollow pipes to increase stiffness and reduce weight, and to limit the centrifugal loadings. Two sets of vertical supports 52, 53 (only one set of which is shown in FIG. 4) support the vane sheets 57, corresponding to vanes 32 and 33 in FIGS. 1A and 1B, along the vertical height of the rotor 50. The vertical supports 52, 53 can also impart the desired curved airfoil profile on to the vane sheet 57. When the rotor vane 50 is rotating in operation, the vertical supports 52, 53 are subjected to centrifugal loadings 54, 55 according to their radial location. Because of the reduced rotor diameter, the loading is increased. Likewise, the long rotor length leads to large radial rotor deflections of the vertical supports 52, 53. The vane sheet 57 tends to simply bend and not significantly resist the deflections of the vertical supports 52, 53. An additional problem resulting from the radial deflections of the vertical supports 52, 53 is the axial contraction 56 of the rotor vane 50. The rotor vane 56 could actually decrease in length as the operational speed increases. The axial contraction 56 can unacceptably overload the bearings of the wind turbine.

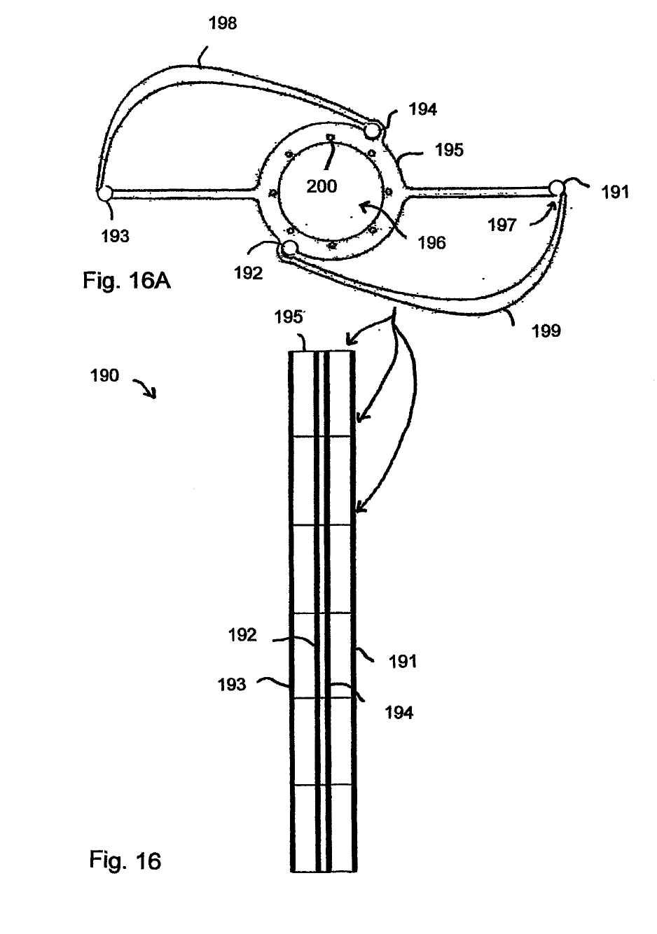

In order to prevent damage to the wind turbine from the centrifugal loading and also to increase the flexural bending stiffness of the rotor for dynamic operation, radial rib members are preferably included on the rotor vanes. A schematic drawing of a single rotor frame with ribs 67 is shown in FIG. 5 in operation. As shown in FIGS. 1A and 1B, the wind turbine rotor will normally have two vanes 60, but only one vane is shown for clarity of illustration. The rotor vane 60 rotates about an axis of rotation 61 and is constructed from two vertical support tubes 62, 63 that support the vane sheet 66. The vertical supports 62, 63 experience significant centrifugal loadings 64, 65 according to their radial locations, as noted above in connection with FIG. 4. The centrifugal loadings 64, 65 are prevented from causing large radial deflections by the addition of radial rib members 67, corresponding to the radial ribs 34 shown in FIG. 1A. The radial rib members 67 extend between the vertical supports 62, 63 and transfer loads between them. One design for rib members 67 is shown in FIG. 16A and described in more detail below. The rib members 67 substantially increase the bending moment of inertia of the vane 60 and form a beam type construction that resists radial deflection and lowers the operating stress. The radial rib members 67 also eliminate the substantial axial contraction of the vane 60 that could overload and fail the wind turbine bearings.

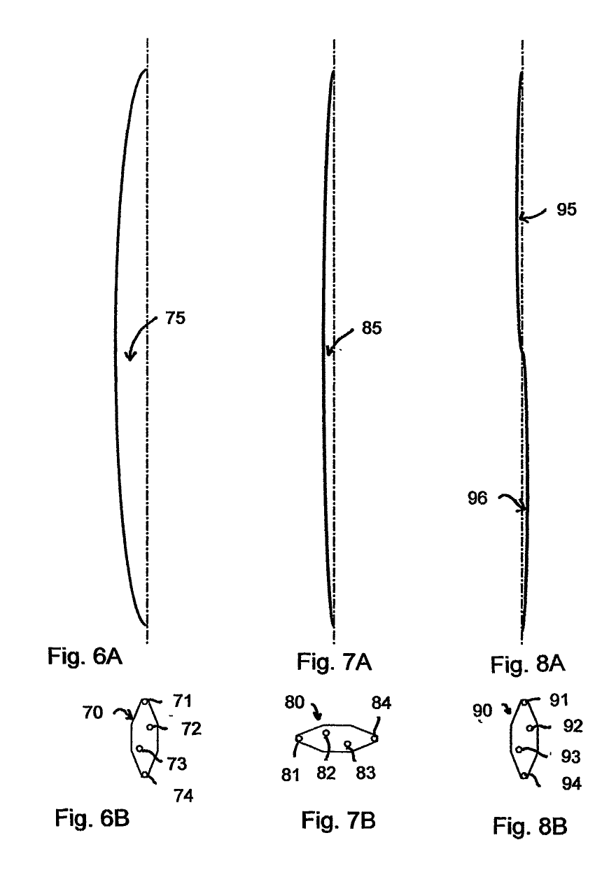

In addition to the centrifugal forces on the wind turbine rotor, the high aspect ratio of the turbine rotor also results in significant dynamic issues. Elimination of flexural critical resonances of the rotor from the operating wind speed range would be difficult to accomplish simply and economically. Such a construction would require use of costly materials and is not desirable in keeping with the goals of the low cost wind turbine. As a result, it is desirable to have the first flexural critical speeds for the rotor to occur at as low a speed as possible. It is desirable to pass through the first criticals, having resonances with the largest geometric deflection capability, with low energy. Low energy transition through these criticals reduces the rotor deflections and resulting stresses in the wind turbine. Preferably the first flexural critical speeds of the rotor occur below the generation speeds and preferably below wind speeds of 4 m/sec. Diagrams of the rotor bending deflection at its first flexural critical about the minimum inertia axis and schematic drawing of the rotor cross-section showing the direction of the minimum inertia axis are shown in FIGS. 6A and 6B. The rotor 70 comprises four vertical supports 71, 72, 73, 74 that are located at two different radial locations, two each for supporting each of the two vane sheets. The minimum inertia axis corresponds to the direction of easiest bending of the rotor and is perpendicular to the vanes. The first flexural mode about the minimum inertia axis results in a large radial deflection 75 and is preferably passed through at low rotational speed and low energy.

A diagram of the rotor bending deflection at its first flexural critical about the maximum inertia axis and a schematic drawing of the rotor cross-section showing the direction of the maximum inertia axis are shown in FIGS. 7A and 7B. The rotor 80 comprises the four vertical supports 81, 82, 83, 84, corresponding to the four vertical supports 71-74 in FIG. 6B, that run the length of the rotor 80 and support the vanes. The maximum axis of inertia is parallel with the vanes. The first critical about the maximum inertia axis bends the rotor with a radial deflection 85 about the center of the height of the rotor 80. Deflection 85 is less than the deflection of the first resonance about the minimum axis of inertia due to the higher stiffness.

A diagram of the rotor bending deflection at its second flexural critical about the minimum inertia axis and a schematic drawing of the rotor cross-section showing the direction of the minimum inertia axis are shown in FIGS. 8A and 8B. The rotor 90 is constructed with the four vertical supports 91, 92, 93, 94, corresponding to the four vertical supports 71-74 in FIG. 6B. The minimum axis of inertia is shown perpendicular with the rotor vanes. For the second critical speed the deflection at the vertical center height of the rotor is zero and the maximum deflections 95, 96 occur away from the center and are much smaller than the first critical speed deflection.

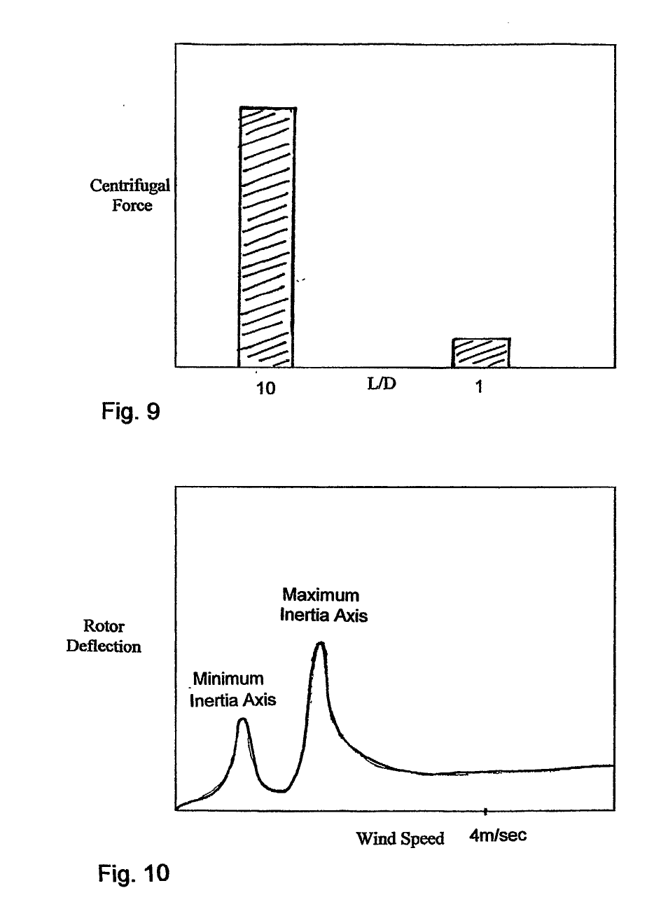

The high aspect ratio of the rotor results in substantially increased centrifugal rotor loading compared with a lower aspect ratio rotor. This surprising result is despite the fact that the rotor operating tip speed ratio and total rotor area may be identical. The drag-propelled rotor operates with a tip speed ratio, which is the ratio of the speed of the vane tip divided by the wind speed. This ratio is a function of the profile of the rotor vane and the power being extracted from the rotor. Changing the aspect ratio does not require a change in the tip speed ratio of the rotor. A reduced rotor diameter from an increased aspect ratio does increase the rotational rate leading to a lower cost generator. However, the centrifugal loading on the rotor is equal to the mass of the rotor times the radius times the rotational rate squared. Hence, the centrifugal loading is equal to the mass times the rotational rate times the rotor tip speed. Since the rotor tip speed remains the same despite the aspect ratio of the rotor, the centrifugal loading is increased from the increased rotational rate. The increased loading becomes even more significant to the rotor deflection because of the long axial length, compounding the problem. A comparison of the rotor centrifugal force versus the rotor L/D ratio in two wind turbine rotors of equal power generation capability is shown in FIG. 9. The increased aspect ratio from one to ten results in ten times higher centrifugal loading on the outer vertical supports of the rotor and vanes.

As explained previously, it is desirable to encounter and pass through the first rotor flexural modes of the rotor at low speed and correspondingly low energy. Transition through the first modes at low speed limits the rotor deflection and rotor stress. A dynamic plot of the rotor deflections with wind speed in accordance with the invention is shown in FIG. 10. The first flexural bending mode of the rotor vanes about the minimum axis of inertia occurs first and at a low wind speed preferably prior to generation of power. The first flexural mode about the maximum axis of inertia of the vanes occurs at a higher speed due to the higher stiffness in that bending direction. Preferably both modes occur below wind speeds of 4 m/sec so as to ensure safe operation and long life of the wind turbine.

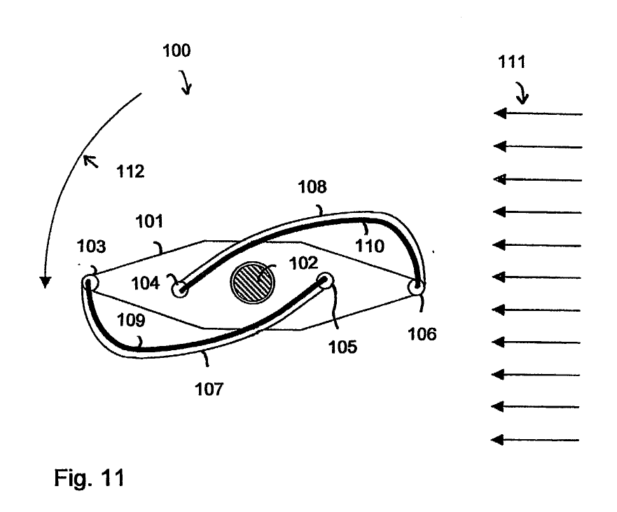

The rotor of the low cost wind turbine is designed to have self-starting operation, low noise and high efficiency in wind energy capture. Savonius rotors have traditionally been constructed using semicircular vane profiles to catch the drag force of the wind. Recent optimizations of Savonius wind turbine profiles have modified the vanes to utilize a more airfoil shaped cross-section. As a result, the power coefficient of the wind turbine utilizes both drag forces and lift forces and the power coefficient has resultantly increased to over 30% with tip speed ratios over 1.5. The vane profile therefore can significantly impact the generation economics of the wind turbine. A schematic drawing of a rotor cross-section in accordance with the invention is shown in FIG. 11. In keeping with the goals of low cost, it is desirable to construct the vanes of the wind turbine from low cost and readily available material sheets, instead of molded composite or thick formed metal vanes that would be very expensive. The rotor 100 is constructed of a rotor end plate 101 that rotates about a stationary center shaft 102. The rotor end plate 101 connects four vertical support tubes 103, 104, 105, 106, corresponding to the four vertical supports 71-74 in FIG. 6B, of the rotor 100. Radial ribs 107, 108 are fastened between the vertical supports 103, 104, 105, 106 to increase that centrifugal strength and flexural bending stiffness and strength of the rotor 100. As shown, the ribs 107, 108 are manufactured with the desired profile for the rotor vanes 109, 110. The vanes 109, 110 are thin plastic panels that are snapped into place on the rotor 100. The vane sheets 109, 110 slide into slots in the vertical support tubes 103, 104, 105, 106, or into slotted support members on the tubes, to clamp the vane sheets 109, 110 into place and support them against centrifugal loading. The ribs 107, 108 force the vane sheets 109, 110 into the vane profile for a high power coefficient rotor. The wind 111 causes the rotor 100 to incur rotation 112 about the stationary center pole 102.

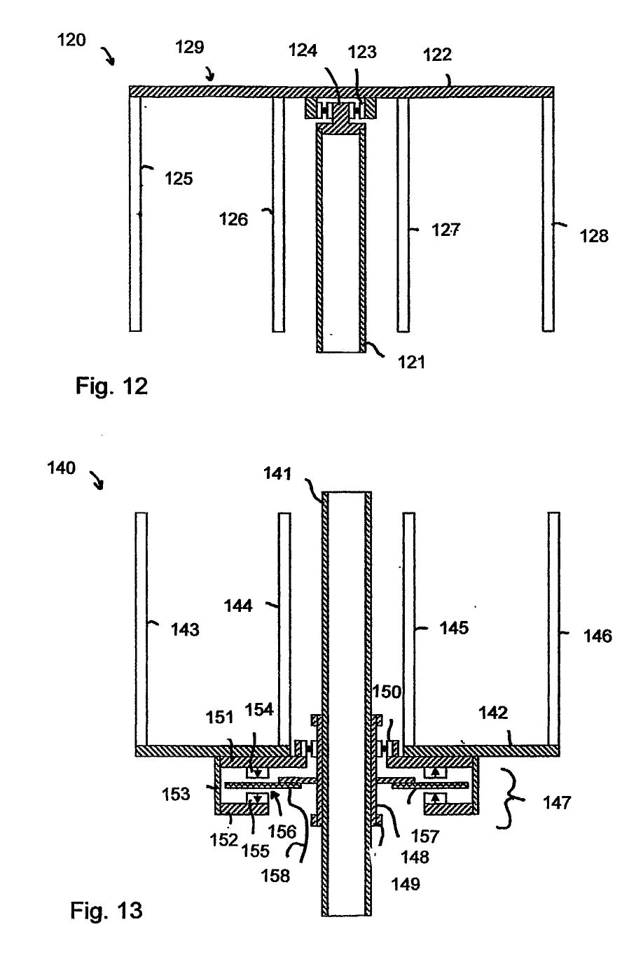

A schematic drawing of the top end of a low cost wind turbine in accordance with the invention is shown in FIG. 12. A rotor 120, mounted to rotate about a stationary vertical center shaft or pole 121, has an upper rotor end plate 122. The end plate 122 is journalled for rotation about the pole 121 by an upper thrust and radial bearing 123 that rides on an upper shaft end 124. By utilizing a stationary center shaft 121 the upper bearing 123 can support the rotor and enable the high aspect ratio without excessive bearing loads that would limit the operating life of the wind turbine. Likewise, the upper bearing 123 can be made smaller than the diameter of the pole 121 for reduced drag and reduced costs. Attached to the upper end plate 122 are the four vertical rotor vane supports 125, 126, 127, 128 that provide the support for and torque transfer from the rotor vanes, not shown for simplicity. Although the rotor is shown with four vertical supports for utilizing two vanes, a higher number of supports and vanes could also be utilized for a different rotor appearance. However, testing has shown that using two rotor vanes produces the most economical energy generation of the wind turbine. The rotor supports 125, 126, 127, 128 are preferably straight vertical tubes, however they may alternatively be employed in a twisted fashion for a helically shaped vane. Helical vanes smooth out rotational torque and may be considered visually appearing but they increase rotor costs and make the vane sheet construction somewhat more difficult and costly.

A schematic drawing of the bottom end of a low cost wind turbine rotor 140 in accordance with the invention is shown in FIG. 13. The low cost wind turbine bottom end could be the bottom end of the turbine rotor 120, the top end of which is shown in FIG. 12, or it could be the bottom end of another version of a wind turbine in accordance with this invention. The rotor 140 rotates about a stationary center pole 141. The rotor 140 is constructed of a lower rotor end plate 142 and four vertical rotor vane support tubes 143, 144, 145, 146 that support the vane sheets, not shown for simplicity. In a preferred embodiment, the wind turbine includes a generator 147 that is attached to the lower end of the rotor 140 so has to keep the weight of the generator at the lowest height. The generator and lower bearing are also assembled as a unit that can be easily installed to the pole 141 and do not require generator magnetic airgap adjustment. The generator 147 is constructed with a center tube 148 that is clamped to the stationary pole 141 with a clamping nut 149. The generator 147 is journalled by a lower bearing 150 that is also attached to the center tube 148. The bearing 150 is also attached to an upper back iron 151 of the generator 147. The generator 147 is constructed from steel back irons 151, 152 that are separated vertically and connected by an outer tube 153. Attached to the back irons 151, 152 are arrays of circumferentially alternating axial polarity magnets 154, 155 that drive magnetic flux back and forth across an armature airgap 156. Located in the armature airgap is a stationary air core armature 157. The air core armature 157 is constructed of multiple windings in a substantially nonmagnetic structure so as to preclude magnetic attraction and the generation of eddy current and hysteresis losses. Preferably the air core armature 157 is constructed from multiple copper wires that are wound onto a plastic form. The air core armature 157 is attached to the center tube 148 to resist rotation by reacting torque back to the center tube and pole 141, and provide the correct height alignment. The electrical power is extracted from the air core armature 157 by electrical connections 158.

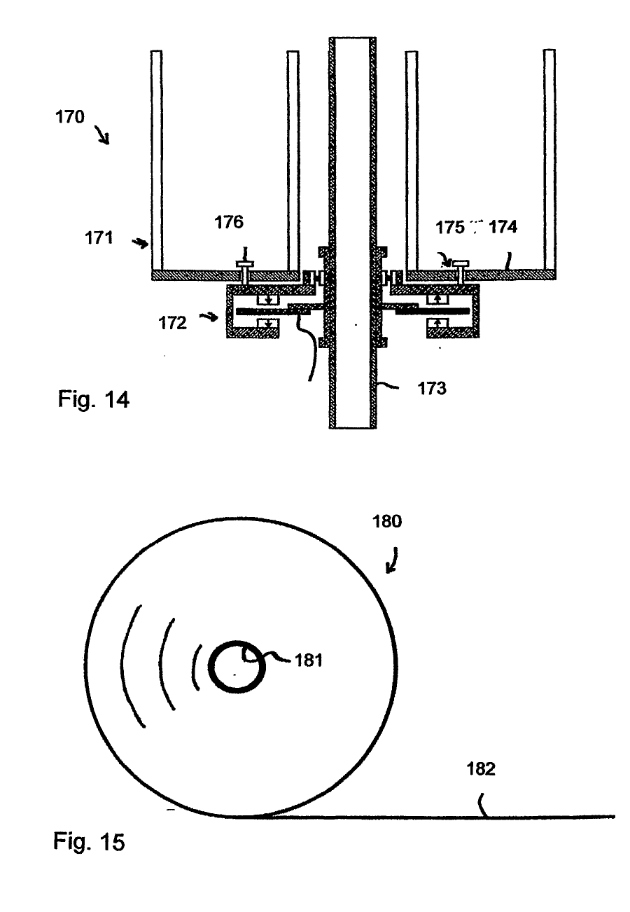

I have found that in operation of axially very long drag propelled cross-wind harnessing rotors, that significant axial deflection can occur for the flexural motion of the rotor. The rotor flexural motion can couple with the flexural motion of the center pole. As a result, very large bearing loads can arise. These large loads affect the smoothness of operation and can be deleterious to the life of the wind turbine bearings. To overcome these effects and still allow for the flexural motions required by both the rotor and the pole, we have found that it is preferable to have an axial sliding connection on at least one end of the rotor that limits axial loading between two bearings supporting the rotor. One such sliding connection can be a slip fit bearing provided with ample displacement room at the top of the rotor. Alternatively, the slip fit can be provided at the bottom of the rotor and through the connection to the generator. A schematic drawing of an alternate configuration of the bottom end of a low cost wind turbine in accordance with the invention is shown in FIG. 14. The wind turbine 170 is comprised of a rotor 171, a generator 172 and a center pole 173. The rotor 171 has a rotor end plate 174 that is provided with slip fit bolt holes 175. Fastening slip bolts 176 are used to axially connect the rotor 171 to the generator. The bolts 176 are allowed sufficient axial space to allow for axial motion between the rotor 171 and generator. A typical space of ¼ inch or more has been found sufficient for rotors of up to 20 foot length. The bolts 176 and oversized holes 175 allow for this axial motion but they transfer the wind induced toque from the rotor 171 to the generator 172 for efficient electrical power generation.

A preferred aspect of the wind turbine is the unique low costs, quiet operation and ability to easier repair the rotor. These benefits can be obtained by constructing the rotor vanes from extruded UV stabilized plastic. A schematic drawing of roll of extruded vane plastic accordance with the invention is shown in FIG. 15. The plastic is extruded in a layer, approximately 1/16^{th} inch has been found to work well. The plastic extrusion is a continuous and low cost process, whereby a roll 180 is produced and rolled up around a core 181 for shipment. The roll 180 is unrolled to cut off the flat panel vanes 182 to the correct rotor length. The plastic vanes, which might be considered to have insufficient strength to operate in high winds, are found to be of more than sufficient strength because of the vane supports and radial ribs. Likewise, they operate very quietly and do not dent. Two preferred materials are UVI HDPE and polycarbonate. Each has very high toughness and good UV stability. The vanes do not need replacement any more often than about every ten years, and they can be produced in any color or pattern, eliminating the need for painting.

A rotor frame in accordance with the invention, showing the vane supports and radial rib members is shown in FIGS. 16 and 16A. The rotor profile has a significant effect on the power coefficient or energy capture ability of the rotor. The rotor 190 is preferably constructed of four steel tubes 191, 192, 193, 194 that are located at two different radial locations. The tubes form the vane supports. Each tube 191, 192, 193, 194 preferably includes axial slots 197 that receive the vane edges when the vanes are slid axially onto the rotor from the top end. The tubes 191, 192, 193, 194 are all connected together through steel radial rib members 195 that are fastened or welded in place every few axial feet along the length of the rotor 190. The radial rib members 195, which can be CNC plasma cut or manufactured by other low cost means, have two ribs 198, 199 that induce the curve shape on the vanes, not shown, when installed. The ribs 198, 199 engage the leading, or radially outer, faces of the vanes. In this location, the ribs 198, 199 hold the vanes into the rotor.

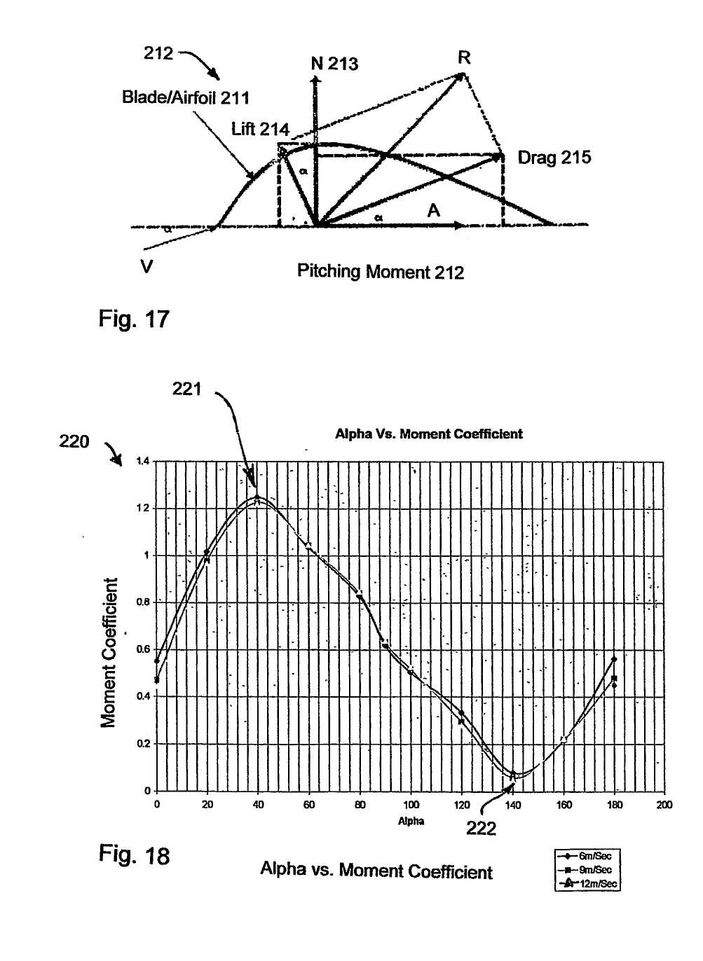

A schematic diagram of the pitching moment generation on a single vane of a rotor in accordance with the invention is shown in FIG. 17. The vane 210 for a rotor half is shown. The airfoil shape 211 of the vane 210 controls the energy extraction from the wind. The profile 211 generates a pitching moment 212 that provides rotor torque. The pitching moment 212 varies with the instantaneous angle of incidence of the impending wind. The torque generation can be resolved into lift forces 214 and drag forces 215 at any and all locations along the profile 211. The sum of all the lift and drag forces 214, 215 along the profile 211 allows determination of the moment coefficient for the vane 210.

Analysis can be applied to calculate the moment coefficient variation for a rotor profile with the variation of the angle of incident wind. This analysis can be applied to determine the energy capture ability of the rotor. A plot of the moment coefficient versus the angle of incidence of impending wind for a rotor in accordance with the invention is shown in FIG. 18. As shown in the plot 220, the moment coefficients hit peaks 221, 222 at about 40° and 140° per each half revolution. Multiple curves show limited effect based on the variations of wind speed. Computational fluid dynamics analysis shows that the drag propelled cross-wind harnessing rotor achieves these moment coefficients with the inclusion lift for low angles of incidence, typically 0-45°. At the angles of 45-90°, moment generation is predominately the result from drag. Self starting cross-wind harnessing turbines require use of some drag component in order to self-start.

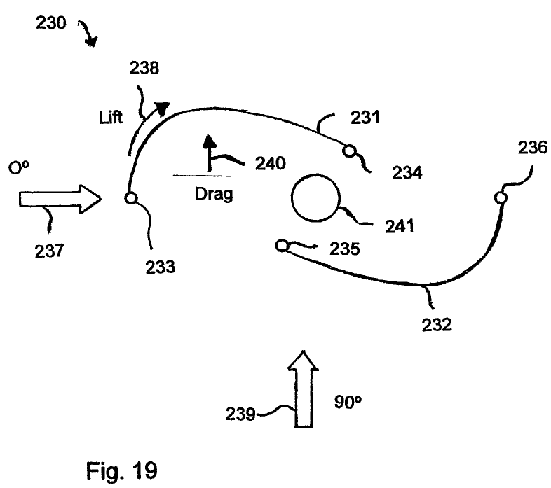

A diagram of a rotor profile showing the torque production from both lift and drag, in accordance with the invention is shown in FIG. 19. The rotor 230 has vanes 231, 232 and vane supports 233, 234, 235, and 236. Low incidence direction wind 237 results is attached flow 238 over the vane 231 and causes torque generation from lift. Higher incidence angle wind 239 results in internal pressure 240 and causes torque generation from drag. The central shaft 241 results in some blockage of the flow between the two vanes 231, 232.

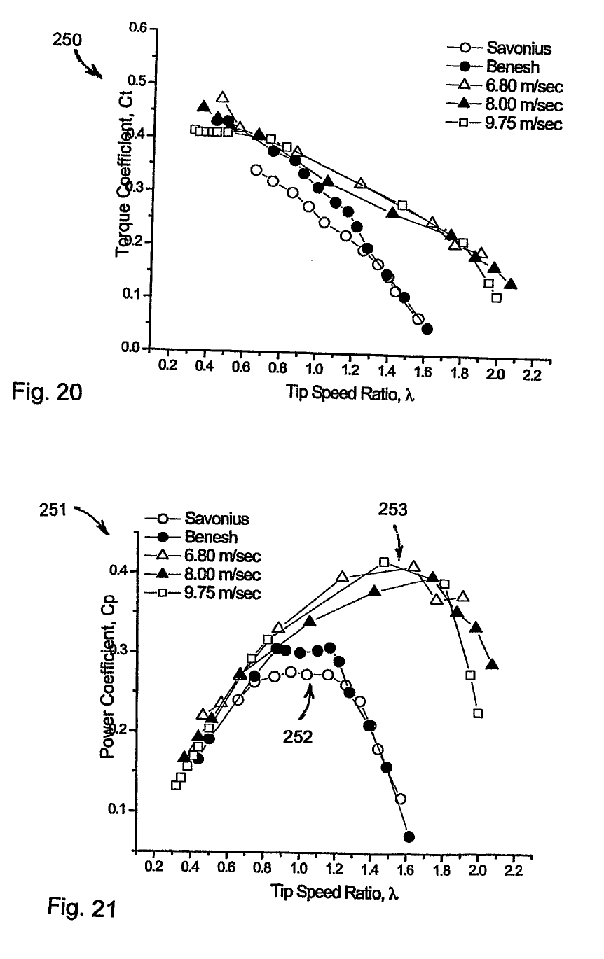

A plot 250 of the rotor torque coefficient versus the rotor operating tip speed ratio for different profile rotors, in accordance with the invention is shown in FIG. 20. The plot 250 shows results for two profiles, Savonius and Benesh, and also a computer optimized Rahai profile with varying wind speeds. The torque coefficients drop with the operating tip speed ratios of the rotor. The operating tip speed ratios of the rotors are controlled by the mechanical torque load that the generator applies to the turbine rotor at any given time for electrical power extraction. As shown, the optimized rotors continue to produce torque for tip speed ratios of up to about 2.1.

The torque coefficients can be used to calculate the power coefficient curves which indicate the efficiency of a rotor profile for extracting energy from the wind for a given cross-sectional area. A plot of the rotor power coefficient versus the rotor operating tip speed ratio for different profile rotors, in accordance with the invention is shown in FIG. 21. The plot 251 shows results for two profiles, Savonius and Benesh, and also a computer optimized profile with varying wind speeds. For the Benesh rotor, the power coefficient achieves a maximum of around 30% and at a tip speed ratio of around 1.1. For the computer optimized Rahai rotor profile, a power coefficient of about 40% is achieved and at a tip speed ratio of about 1.5. The higher power coefficient increases the energy production of the wind turbine. The higher tip speed ratio further allows the generator to rotate faster for a given wind speed and allows the generator costs to be reduced. Any of the profiles can be utilized in the wind turbine. Each is very easy implemented using the low cost turbine construction. The radial ribs are simply cut or formed to the correct desired profile to obtain the desired performance. The replaceable vanes are installed and take the profile shape. No large rotor molding operations are required.

Obviously, numerous modifications and variations of the described preferred embodiment are possible and will occur to those skilled in the art in light of this disclosure of the invention. Accordingly, I intend that these modifications and variations, and the equivalents thereof, be included within the spirit and scope of the invention as defined in the following claims, wherein

I claim:

1. A vertical axis wind turbine comprising;
a pole adapted to be installed in a vertical orientation, a drag propelled cross-wind harnessing rotor mounted on said pole, and an electric generator coupled to and driven by said rotor;
said rotor comprises two axially elongated, radially curved, fixed and axially untwisted rotor vanes mounted such that said rotor incurs a high aspect ratio having a length, L, and diameter, D, wherein 5≦L/D;
said rotor is constructed from thin replaceable vane sheets that form said two curved vanes, and vertically extending rigid vane supports that are located at two different radial locations on said rotor, said vane supports supporting said vane sheets and providing transfer of the wind induced torque along the vane sheet length to said generator;
said rotor further comprises multiple radial rib members that extend between said rigid vane supports at different axial locations along the vertical length of said rotor, wherein said radial rib members increase the radial bending stiffness of said rotor vanes in rotational operation;
said rotor is supported to rotate about said pole by upper and lower bearings such that said pole operates as a stationary center shaft;
said generator is located at one end of said rotor and connected thereto to convert rotational energy of said rotor into electricity, said generator rotor rotates about said central pole and is directly driven by said rotor at the same rotational speed.

2. A vertical axis wind turbine as described in claim 1 wherein:
said radial ribs have a curved profile that induces a curved shape to said vane sheets when installed and said radial ribs are located on a leading face of said vanes.

3. A vertical axis wind turbine as described in claim 1 wherein:
said rigid vane supports are constructed from hollow tubes.

4. A vertical axis wind turbine as described in claim 1 wherein:
said rotor has a radial direction bending stiffness, mass per length, rotor diameter and tip speed ratio such that said rotor passes through a first radial direction flexural rotor critical speed at a wind speed below 4 m/sec.

5. A vertical axis wind turbine as described in claim 1 wherein:
said rigid vane supports retain the outer vertical edges of said vane sheets substantially near the outer diameter of said rotor.

6. A vertical axis wind turbine as described in claim 5 wherein:
said rigid vane supports have vertical extending slots vane that receive and retain the vane edges of said vane sheets when placed into said slots.

7. A vertical axis wind turbine as described in claim 1 wherein:
said generator is constructed of multiple permanent magnet poles that drive magnetic flux across an armature airgap that contains an air core armature with multiple electrical windings, said armature airgap is bounded on both surfaces by rotating surfaces of the generator rotor.

8. A vertical axis wind turbine as described in claim 1 wherein:
at least one end of said rotor comprises axial sliding connection that limits the axial loading between two of the said bearings supporting said rotor.

9. A vertical axis wind turbine as described in claim 1 wherein:
said rotor aspect ratio is limited, wherein 15≧L/D;

10. A vertical axis wind turbine as described in claim 1 wherein:
said rigid vane supports are constructed of metal and said vanes are constructed of extruded plastic.

11. A vertical axis wind turbine comprising;
a stationary structure installed to create a vertical rotational axis, a drag propelled cross-wind harnessing rotor mounted on said stationary structure, and an electric generator coupled to and driven by said rotor;
said rotor comprises two axially extending, radially curved, fixed and axially untwisted rotor vanes assembled on said rotor and providing a maximum power coefficient that occurs between a tip speed ratio of 0.7 to 2.1;
said rotor is constructed from thin replaceable plastic vane sheets that form said two curved vanes and are supported along their vertical length by vertically extending metal vane supports that are located at two different radial locations on said rotor, said vane supports supporting said vane sheets and providing transfer of the wind induced torque along the vane sheet length;
said rotor further comprises multiple radial rib members that extend between said rigid vane supports at different axial locations along the vertical length of said rotor, wherein said radial rib members induce the shape of the curves of said vane sheets;
rotation of said rotor drives said generator and converts rotational energy of said rotor into electricity.

12. A vertical axis wind turbine as described in claim 11 wherein:
said metal vane supports are constructed from hollow tubes;

13. A vertical axis wind turbine as described in claim 11 wherein:
said metal vane supports retain the outer edges of said vane sheets substantially near the outer diameter of said rotor.

14. A vertical axis wind turbine as described in claim 11 wherein:
said metal vane supports have vertical extending slots and said vanes axially slide into said slots.

15. A vertical axis wind turbine as described in claim 11 wherein:
said generator is constructed of multiple permanent magnet poles that drive magnetic flux across an armature airgap that contains an air core armature with multiple electrical windings, said armature airgap is bounded on both surfaces by rotating surfaces of the generator rotor.

16. A vertical axis wind turbine comprising;
a pole adapted to be installed in a vertical orientation, a drag propelled cross-wind harnessing rotor mounted on said pole, and an electric generator coupled to said rotor;
said rotor comprises two axially elongated, radially curved, fixed and axially untwisted rotor vanes mounted such that said rotor imparts a high aspect ratio having a length, L, and diameter, D, wherein 5≦L/D≦15;
said rotor is constructed from thin replaceable vane sheets that form two curved vanes;
said rotor comprises multiple radial rib members along the vertical length of said rotor that extend in a radially outward curve to the outer diameter of said rotor, wherein said radial ribs have a curved profile that induces a curved shape to said vane sheets when installed and said radial ribs are located on a leading face of said vanes;
said rotor is supported to rotate about said pole by upper and lower bearings such that said pole operates as a stationary center shaft;
said generator is located at one end of said rotor and connected thereto to convert rotational energy of said rotor into electricity, said generator rotor rotates about said central pole and is directly driven by said rotor at the same rotational speed.

17. A vertical axis wind turbine as described in claim 16 wherein:
said rotor has a radial direction bending stiffness, mass per length, rotor diameter and tip speed ratio such that said rotor encounters a first radial direction flexural rotor critical speed at a wind speed below 4 m/sec.

18. A vertical axis wind turbine as described in claim 16 wherein:
said generator is constructed of multiple permanent magnet poles that drive magnetic flux across an armature airgap that contains an air core armature with multiple electrical windings, said armature airgap is bounded on both surfaces by rotating surfaces of the generator rotor.

19. A vertical axis wind turbine as described in claim 16 wherein:
said vanes axially slide into said rotor.

20. A vertical axis wind turbine as described in claim 16 wherein:
said vanes are constructed of extruded plastic and said radial ribs are located on a leading face of said vanes.
